(19) United States
(12) Patent Application Publication
(10) Pub. No.: US 2025/0171615 A1
(43) Pub. Date: May 29, 2025

(54) RESIN COMPOSITION, ADHESIVE MEMBER, AND DISPLAY DEVICE INCLUDING THE ADHESIVE MEMBER

(71) Applicant: Samsung Display Co., LTD., Yongin-si (KR)

(72) Inventor: Yosuke SAITO, Yokohama (JP)

(21) Appl. No.: 18/948,110

(22) Filed: Nov. 14, 2024

(30) Foreign Application Priority Data
Nov. 27, 2023 (KR) 10-2023-0167120

(51) Int. Cl. C08K 5/132; C08F 220/18; C08F 220/20; C08F 220/28; C08F 222/10; C08K 5/5397; C09J 4/06; C09J 11/06

(52) U.S. Cl. CPC C08K 5/132; C08F 220/1808; C08F 220/20; C08F 220/281; C08F 222/1065; C08K 5/5397; C09J 4/06; C09J 11/06; C09J 2203/318; C09J 2301/416; C09J 2433/00

(57) ABSTRACT

Provided is a resin composition that may include a dihydroxybenzophenone-based ultraviolet absorber, a photoinitiator that absorbs light in a wavelength region of about 400 nm to about 450 nm, at least one monofunctional (meth)acrylate monomer and at least one (meth)acrylate oligomer. The resin composition after photocuring has a 180° peel force of about 800 gf/25 mm or greater for at least one among a glass substrate and a polymer substrate at about 25° C. Therefore, the resin composition may show excellent applicability before being cured and may show excellent adhesion after being cured.

### CROSS-REFERENCE TO RELATED APPLICATIONS

The present application claims priority to and the benefit of Korean Patent Application No. 10-2023-0167120, filed on Nov. 27, 2023, in the Korean Intellectual Property Office, the entire content of which is hereby incorporated by reference.

### BACKGROUND

Embodiments of the present disclosure herein relate to a resin composition, an adhesive member made of or from the resin composition, and a display device including the adhesive member.

The development of various display devices used in multimedia apparatuses, such as, for example, televisions, mobile phones, tablets, navigation systems, and game consoles, is being conducted. The display devices include various components constituting the display devices, and an adhesive member is between at least some of the components. The adhesive member may be formed by providing one or more resin compositions, and the adhesive member included in the display devices has characteristics that stably combine the components of the display devices and do not deteriorate display quality.

### SUMMARY

Embodiments of the present disclosure provide a resin composition showing excellent applicability before being cured and having strong adhesion after being cured, an adhesive member made of or from the resin composition, and a display device including the adhesive member.

An embodiment of the present disclosure provides a resin composition including a dihydroxybenzophenone-based ultraviolet absorber, a photoinitiator that absorbs light in a wavelength region of about 400 nm to about 450 nm, at least one monofunctional (meth)acrylate monomer; and at least one (meth)acrylate oligomer, wherein, the resin composition after photocuring has a 180° peel force of about 800 gf/25 mm or greater for at least one among a glass substrate and a polymer substrate, as measured at about 25° C. according to the JIS Z0237 standard.

In an embodiment, the resin composition may have a transmittance of about 0% or greater and less than about 5% after photocuring for light having a wavelength of about 400 nm and a transmittance of about 85% to about 99% after photocuring for light having a wavelength of about 450 nm.

In an embodiment, the dihydroxybenzophenone-based ultraviolet absorber may include 2,2′,4,4′-tetrahydroxybenzophenone.

In an embodiment, the dihydroxybenzophenone-based ultraviolet absorber may have a weight of about 2 wt % to about 10 wt % with respect to 100 wt % of the total weight of the resin composition.

In an embodiment, the photoinitiator may include bis(2,4,6-trimethylbenzoyl)phenyl phosphine oxide.

In an embodiment, the (meth)acrylate oligomer may have a weight-average molecular weight of about 5,000 to about 40,000.

In an embodiment, the monofunctional (meth)acrylate monomer may include at least one among 4-hydroxybutyl acrylate (4-HBA), 2-ethylhexyl acrylate (2-EHA), tetrahydrofurfuryl acrylate (THF-A), and 2-ethylhexyl-diglycol acrylate (EHDG-AT).

In an embodiment, the monofunctional (meth)acrylate monomer may have a weight of about 75 wt % to about 85 wt % with respect to 100 wt % of the total weight of the resin composition.

In an embodiment, the resin composition may be provided through an inkjet printing method and/or a dispensing method.

In an embodiment of the present disclosure, an adhesive member includes a polymer derived from a resin composition including a dihydroxybenzophenone-based ultraviolet absorber, a photoinitiator that absorbs light in a wavelength region of about 400 nm to about 450 nm, at least one monofunctional (meth)acrylate monomer and at least one (meth)acrylate oligomer, wherein, the adhesive member has a 180° peel force of about 800 gf/25 mm or greater for at least one of a glass substrate or a polymer substrate, as measured at 25° C. according to the JIS Z0237 standard.

In an embodiment, the adhesive member may have a transmittance of about 0% or greater and less than about 5% for light having a wavelength of about 400 nm and may have a transmittance of about 85% to about 99% for light having a wavelength of about 450 nm.

In an embodiment, the dihydroxybenzophenone-based ultraviolet absorber may include 2,2′,4,4′-tetrahydroxybenzophenone.

In an embodiment, the dihydroxy benzophenone-based ultraviolet absorber may have a weight of about 2 wt % to about 10 wt % with respect to 100 wt % of the total weight of the resin composition.

In an embodiment, the photoinitiator may include bis(2,4,6-trimethylbenzoyl)phenyl phosphine oxide.

In an embodiment, the (meth)acrylate oligomer may have a weight-average molecular weight of about 5,000 to about 40,000.

In an embodiment of the present disclosure, a display device includes a display panel, a window on the display panel, and an adhesive member between the display panel and the window, and having a 180° peel force of about 800 gf/25 mm or greater for at least one among a glass substrate and a polymer substrate, as measured at 25° C. according to the JIS Z0237 standard, wherein the adhesive member includes a polymer derived from a resin composition including a in a wavelength region of about 400 nm to about 450 nm, at least one monofunctional (meth)acrylate monomer and at least one (meth)acrylate oligomer.

In an embodiment, the adhesive member may have a transmittance of about 0% or greater and less than about 5% for light having a wavelength of about 400 nm and a transmittance of about 85% to about 99% for light having a wavelength of about 450 nm.

In an embodiment, the dihydroxybenzophenone-based ultraviolet absorber may include 2,2′,4,4′-tetrahydroxybenzophenone

In an embodiment, the weight of the dihydroxybenzophenone-based ultraviolet absorber may be about 2 wt % to about 10 wt % with respect to 100 wt % of the total weight of the resin composition.

In an embodiment, the photoinitiator may include bis(2,4,6-trimethylbenzoyl)phenyl phosphine oxide.

In an embodiment, the display device may include no polarizer (e.g., the display device may not include a polarizer, a polarizer may not be present in the display device, or the display device may be free of a polarizer).

In an embodiment, the display device may further include an input-sensing part between the display panel and the window, wherein the adhesive member is between the display panel and the input-sensing part, or between the input-sensing part and the window.

### BRIEF DESCRIPTION OF THE DRAWINGS

The accompanying drawings are included to provide a further understanding of the subject matter of the present disclosure, and are incorporated in and constitute a part of this specification. The drawings illustrate embodiments of the present disclosure and, together with the description, serve to explain principles of the present disclosure. In the drawings:

FIG. 1 is a perspective view illustrating a display device according to an embodiment;

FIG. 2 is an exploded perspective view illustrating a display device according to an embodiment;

FIG. 3 is a cross-sectional view illustrating a section taken along line I-I′ in FIG. 1;

FIG. 4 is a cross-sectional view illustrating a portion of a display device according to an embodiment;

FIG. 5A is a view schematically showing a method of manufacturing an adhesive member according to an embodiment;

FIG. 5B is a view schematically showing a method of manufacturing an adhesive member according to an embodiment;

FIG. 5C is a view schematically showing a method of manufacturing an adhesive member according to an embodiment;

FIG. 5D is a view schematically showing a method of manufacturing an adhesive member according to an embodiment;

FIG. 6A is a view schematically showing a method of manufacturing an adhesive member according to an embodiment;

FIG. 6B is a view schematically showing a method of manufacturing an adhesive member according to an embodiment;

FIG. 6C is a view schematically showing a method of manufacturing an adhesive member according to an embodiment;

FIG. 7 is a cross-sectional view illustrating a display device according to an embodiment;

FIG. 8 is a cross-sectional view illustrating a display device according to an embodiment; and

FIG. 9 is a view illustrating a vehicle in which a display device according to an embodiment is provided.

### DETAILED DESCRIPTION

In the subject matter of the present disclosure, various suitable modifications may be made, various suitable forms may be applied, and example embodiments will be illustrated in the drawings and described in more detail in the text. However, this is not intended to limit the subject matter of the present disclosure to a specific disclosure form, and it should be understood to include all changes, equivalents, and substitutes included in the spirit and scope of the present disclosure.

It will be understood that when a component (or region, layer, part, etc.) is referred to as being “on”, “connected to” or “coupled to” another component, it can be directly on/connected to/coupled to the other component or intervening components may be present therebetween.

The same reference numerals or symbols refer to the same elements. In addition, in the drawings, thicknesses, ratios, and dimensions of components may be exaggerated for an effective description of technical content. The term “and/or” includes all combinations of one or more that the associated components may define.

Terms such as first, and second may be used to describe various components, but the components should not be limited by the terms. These terms are only used for the purpose of distinguishing one component from other components. For example, without departing from the scope of the present disclosure, a first component may be referred to as a second component, and similarly, the second component may be referred to as the first component. Singular expressions include plural expressions unless the context clearly indicates otherwise.

In addition, terms such as “below”, “under”, “above”, and “on the upper side” are used to describe the relationship between components shown in the drawings, but the present disclosure is not limited thereto. The terms are relative concepts and are described based on the directions indicated in the drawings, but the present disclosure is not limited thereto.

Terms such as “include” or “have” are intended to specify the presence of a stated feature, integer, step, operation, component, part, or combination thereof described in the specification, and it should be understood that it does not preclude the possibility of the presence or addition of one or more other features, integers, steps, operations, components, parts, or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

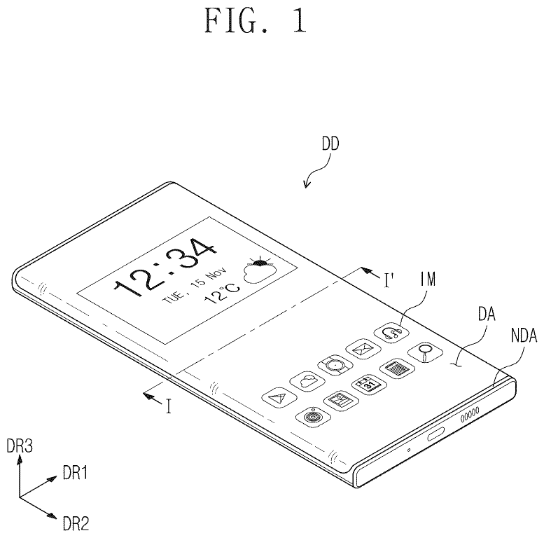

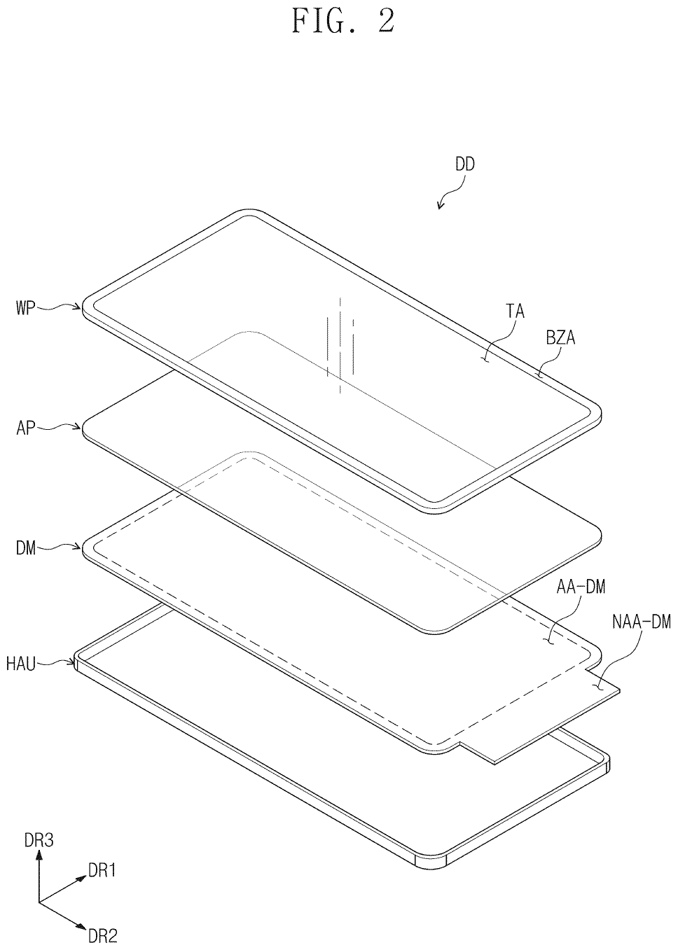

Hereinafter, an adhesive member according to an embodiment of the present disclosure and a display device including the same will be explained in more detail with reference to the accompanying drawings. FIG. 1 is a perspective view illustrating a display device according to an embodiment. FIG. 2 is an exploded perspective view of a display device according to an embodiment.

A display device DD according to an embodiment illustrated in FIG. 1 may be a device activated in response to electrical signals. For example, the display device DD may be a personal computer, a laptop computer, a personal digital terminal, a game console, a portable electronic device, a television, a monitor, an outdoor billboard, a car navigation unit, and/or a wearable device, but an embodiment of the present disclosure is not limited thereto. In FIG. 1, the display device DD is shown as a smartphone as an example.

The display device DD according to an embodiment may display an image IM through a display region DA. The display region DA may include a plane defined by a first direction axis DR1 and a second direction axis DR2. The display region DA may include a curved surface bent from at least one side of the plane defined by the first direction axis DR1 and the second direction axis DR2. The display device DD according to an embodiment, illustrated in FIG. 1, is shown to include two curved surfaces each bent from both sides (e.g., two opposing sides) of the plane defined by the first direction axis DR1 and the second direction axis DR2. However, a shape of the display region DA is not limited thereto. For example, the display region DA may only include the plane defined by the first direction axis DR1 and the second direction axis DR2, and may further include curved surfaces bent from at least two sides, for example, four curved surfaces respectively bent from four sides, of the plane defined by the first direction axis DR1 and the second direction axis DR2.

The display device DD according to an embodiment may be flexible. The term “flexible” may mean characteristics capable of being bent, and may include all from a fully foldable structure to a structure capable of being bent in a nanometer scale. For example, the display device DD may be foldable. In embodiments, the display device DD may be rigid.

A non-display region NDA may be adjacent to the display region DA. The non-display region NDA may surround the display region DA. Therefore, the shape of the display region DA may be substantially defined by the non-display region NDA. However, this is illustrated as an example, and the non-display region NDA may be adjacent to only one side of the display region DA or may be omitted. The display region DA may be provided to have various suitable shapes and is not limited to any one embodiment.

In FIG. 1 and the following drawings, first direction axis DR1 to third direction axis DR3 are illustrated, and directions indicated by the first to third direction axes DR1, DR2, and DR3, which are explained in the present specification, are relative concepts and may be converted into other directions. In embodiments, the directions indicated by the first to third direction axes DR1, DR2, and DR3 may be described as first to third directions, and the same reference symbols and numerals may be used. As used herein, the first direction axis DR1 and the second direction axis DR2 may be perpendicular to each other, and the third direction axis DR3 may be a normal direction of the plane defined by the first direction axis DR1 and the second direction axis DR2.

A thickness direction of the display device DD may be parallel to the third direction axis DR3, which is the normal direction of the plane defined by the first direction axis DR1 and the second direction axis DR2. As used herein, a front surface (or a top surface, an upper surface, or an upper side) and a rear surface (or a bottom surface, a lower surface, or a lower side) of members constituting the display device DD may be defined with respect to the third direction axis DR3. In embodiments, as used herein, an extended direction of the third direction axis DR3 is parallel to the thickness direction, the front surface (or a top surface, an upper surface, or an upper side) means an adjacent surface (or direction) to a surface on which the image IM is displayed, and the rear surface (or a bottom surface, a lower surface, or a lower side) means a surface spaced apart from the surface (or direction) on which the image IM is displayed. As used herein, a plane means a surface parallel to the plane defined by the first direction axis DR1 and the second direction axis DR2, and a cross-section means a surface that is perpendicular to the plane defined by the first direction axis DR1 and the second direction axis DR2 and is parallel to the thickness direction DR3.

Referring to FIG. 2, the display device DD may include a display module DM, a window WP on the display module DM, and an adhesive member between the display module DM and the window WP. In embodiments, the display device DD may further include a housing HAU in which the display module DM is accommodated.

In the display device DD illustrated in FIG. 1 and FIG. 2, the window WP and the housing HAU may be combined to thereby constitute an exterior of the display device DD. The housing HAU may be below the display module DM. The housing HAU may include materials having relatively high rigidity. For example, the housing HAU may include a plurality of plates and/or frames, which are made of glasses, plastics, and/or metals. The housing HAU may provide a set or predetermined accommodation space. The display module DM may be accommodated in the accommodation space to thereby be protected from an external shock.

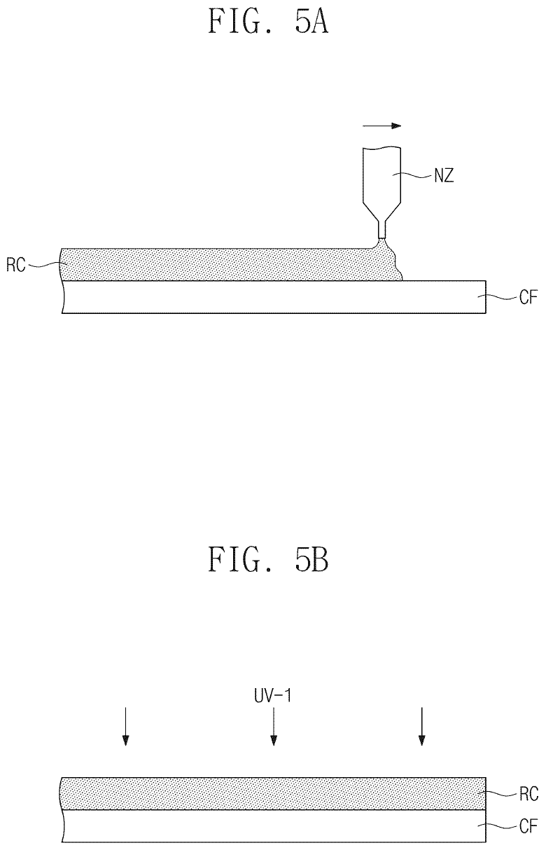

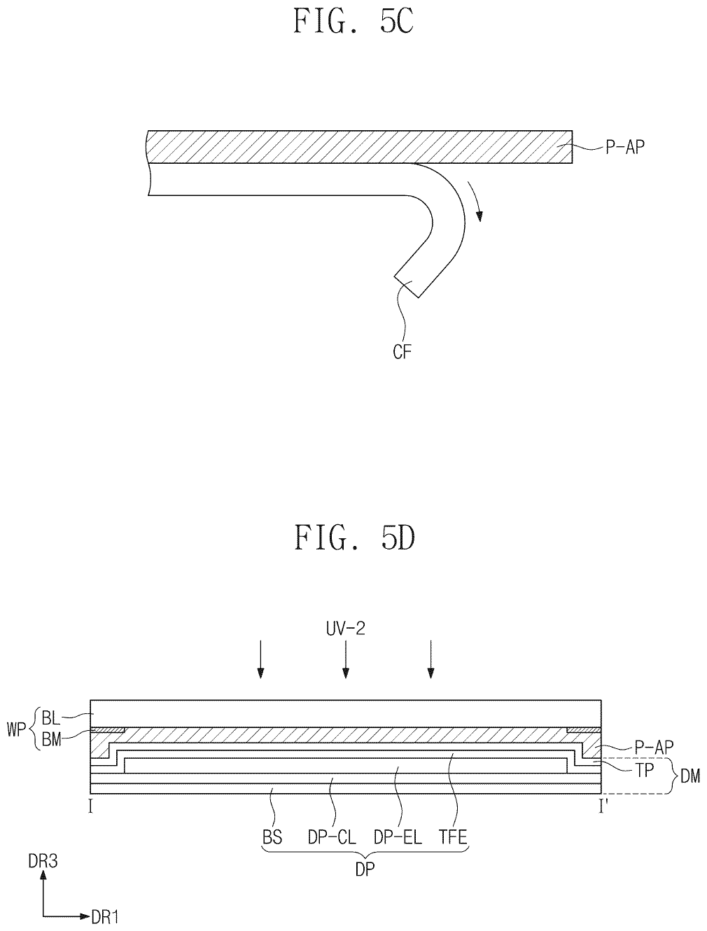

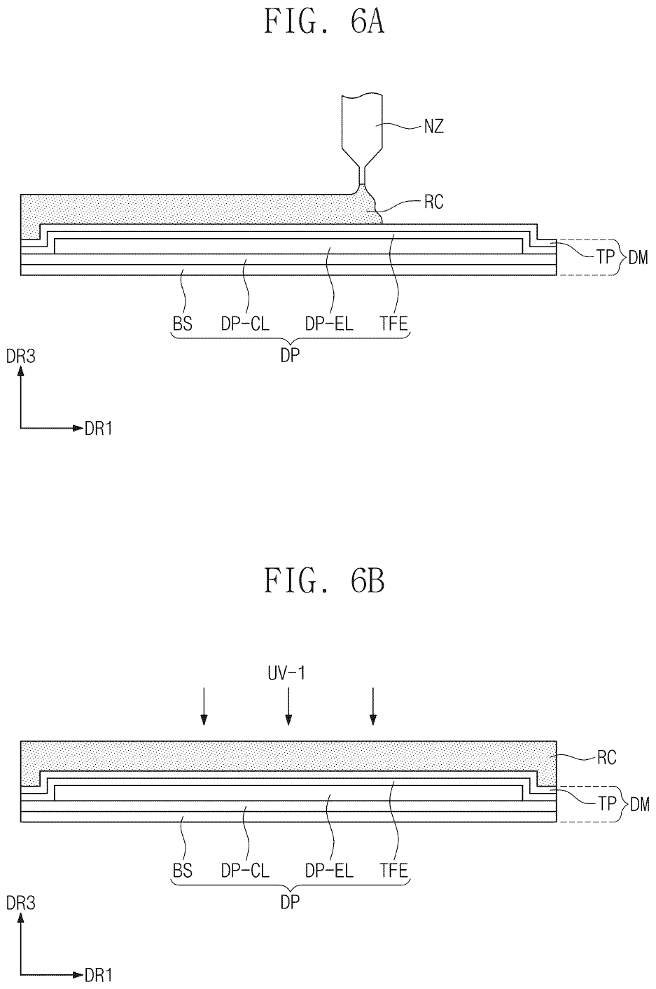

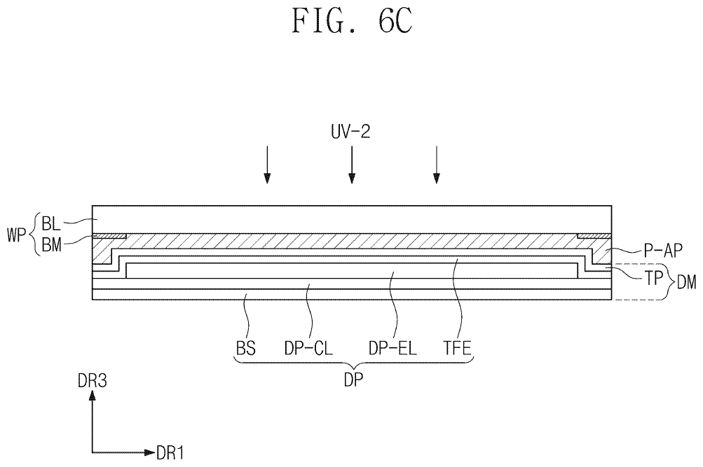

In an embodiment, the adhesive member AP may include a polymer derived from a resin composition RC (FIG. 5A and FIG. 6A). The adhesive member AP may be formed by photocuring the resin composition RC (FIG. 5A and FIG. 6A). The display module DM and the window WP may be bonded by the adhesive member AP. The adhesive member AP may be formed from the resin composition RC (FIG. 5A and FIG. 6A) including an ultraviolet absorber to thereby prevent or reduce damage to the display module DM due to external light (for example, ultraviolet light). In embodiments, the adhesive member AP may exhibit excellent adhesion while preventing or reducing damage to the display module DM.

The window WP may include a transmissive region TA and a bezel region BZA. The transmissive region TA may overlap at least a portion of an active region AA-DM of the display module DM. The transmissive region TA may be optically transparent. The image IM (FIG. 1) may be provided to the user through the transmissive region TA.

The bezel region BZA may have a relatively lower light transmittance than the transmissive region TA. The bezel region BZA may define a shape of the transmissive region TA. The bezel region BZA may be adjacent to the transmissive region TA and may surround the transmissive region TA.

The bezel region BZA may have a set or predetermined color. The bezel region BZA may cover a peripheral region NAA-DM of the display module DM to thereby prevent the peripheral region NAA-DM from being viewed from the outside or to reduce the visibility of the peripheral region NAA-DM from the outside. However, an embodiment of the present disclosure is not limited to what is illustrated, the bezel region BZA may be adjacent to only one side of the transmissive region TA, and/or at least a portion thereof may be omitted.

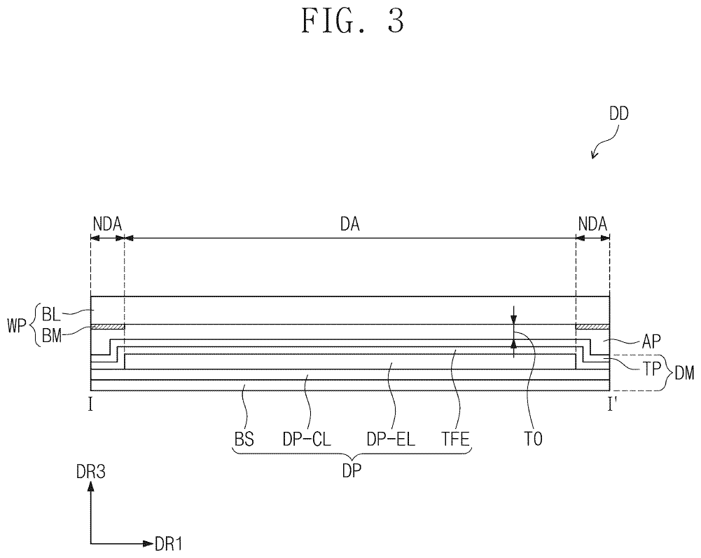

FIG. 3 is a cross-sectional view illustrating the display module DM, the adhesive member AP, and the window WP in FIG. 2. In embodiments, FIG. 3 may be a cross-sectional view illustrating the display device DD according to an embodiment.

Referring to FIG. 3, the display module DM may include a display panel DP and an input-sensing part TP on the display panel DP. The display panel DP may be a component that substantially generates an image. The display panel DP may include a base substrate BS, a circuit layer DP-CL on the base substrate BS, a display element layer DP-EL on the circuit layer DP-CL, and an encapsulation layer TFE that covers the display element layer DP-EL. The adhesive member AP may be between the display panel DP and the window WP.

Configurations of the display panel DP illustrated in FIG. 3 and the like are for illustrative purposes and the present disclosure is not limited thereto. For example, the display panel DP may include a liquid display element, and in embodiments, the encapsulation layer TFE may be omitted.

The base substrate BS may provide a base surface in which the circuit layer DP-CL is provided. The base substrate BS may be a flexible substrate capable of being bent, folded, rolled, and/or the like. The base substrate BS may be a glass substrate, a metal substrate, a polymer substrate, etc. However, an embodiment of the present disclosure is not limited thereto, and the base substrate BS may include an inorganic layer, an organic layer, or a composite material layer including an inorganic material and an organic material.

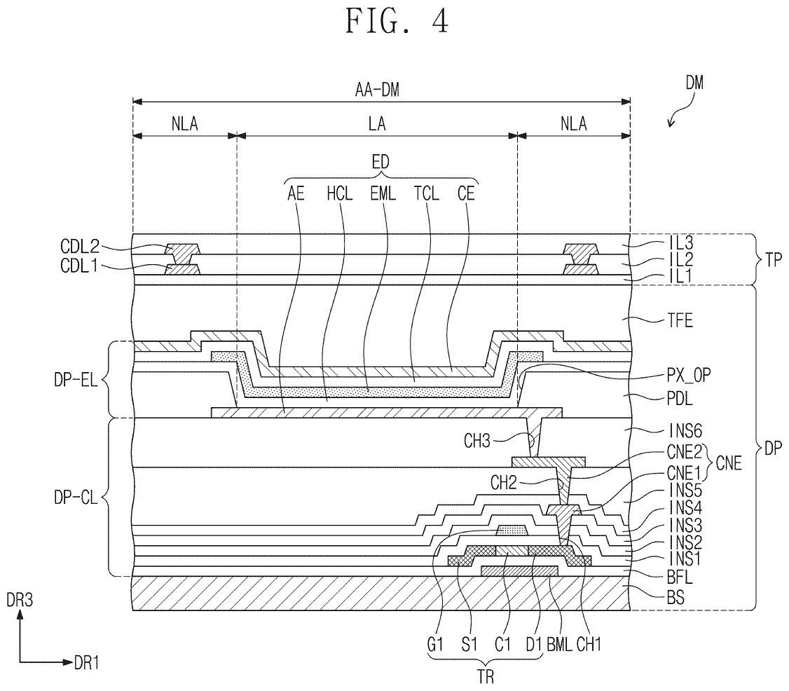

The circuit layer DP-CL may include an insulation layer, a semiconductor pattern, a conductive pattern, signal lines, etc. For example, the circuit layer DP-CL may include a switching transistor and a driving transistor for driving a light-emitting element ED (FIG. 4) of the display element layer DP-EL, which will be further described below.

The display element layer DP-EL may include the light-emitting element ED (FIG. 4) that emits light. For example, the light-emitting element ED (FIG. 4) may include an organic emission material, an inorganic emission material, an organic-inorganic emission material, a quantum dot, a quantum rod, a micro LED, and/or a nano LED.

The encapsulation layer TFE may be on the display element layer DP-EL. The encapsulation layer TFE may protect the display element layer DP-EL from moisture, oxygen, and/or foreign materials such as, for example, dust particles. The encapsulation layer TFE may include at least one inorganic layer. For example, the encapsulation layer TFE may include an inorganic layer, an organic layer, and an inorganic layer, which are sequentially stacked.

The input-sensing part TP may be on the display panel DP. For example, the input-sensing part TP may be directly on the encapsulation layer TFE of the display panel DP. In embodiments, an adhesive layer may also be between the input-sensing part TP and the display panel DP.

As used herein, it will be understood that when an element is referred to as being directly disposed/provided on another element, there is no third element disposed/provided between the element and the other element. For example, when one element is referred to as being ‘directly disposed/provided’, the one element ‘contacts’ the other element.

The input-sensing part TP may detect an input from the outside, convert the same to a set or predetermined input signal, and provide the input signal to the display panel DP. For example, in the display device DD according to an embodiment, the input-sensing part TP may be a touch-sensing part that detects a touch. The input-sensing part TP may detect the user's direct touch, the user's indirect touch, direct touch by an object, indirect touch by an object, etc.

The input-sensing part TP may detect at least any one among a position and intensity (pressure) of touch applied from the outside. In an embodiment, the input-sensing part TP may have various suitable structures or be made of various suitable materials but is not limited to any one embodiment. For example, the input-sensing part TP may detect external inputs by a capacitive method. The display panel DP may be provided an input signal from the input-sensing part and may generate an image corresponding to the input signal.

The window WP may include a base layer BL and a printing layer BM. In embodiments, the window WP may further include at least one functioning layer provided on the base layer BL. For example, the functioning layer may be a hard coating layer, an anti-fingerprint coating layer, etc., but an embodiment of the present disclosure is not limited thereto.

The base layer BL may be a glass substrate. In embodiments, the base layer BL may be a plastic substrate. For example, the base layer BL may be formed of polyimide, polyacrylate, polymethylmethacrylate, polycarbonate, polyethylenenaphthalate, polyvinylidene chloride, polyvinylidene difluoride, polystyrene, an ethylene vinyl alcohol copolymer, or a combination thereof.

The printing layer BM may be on one side of the base layer BL. The printing layer BM may be on a bottom surface of the base layer BL adjacent to the display module DM. The printing layer BM may be provided in an edge region of the base layer BL. The printing layer BM may be an ink printing layer. In embodiments, the printing layer BM may include a pigment and/or a dye. In the window WP, the bezel region BZA may be a portion in which the printing layer BM is provided.

The adhesive member AP may have a thickness of about 50 μm to about 200 μm. For example, the adhesive member AP may have a thickness TO of about 50 μm to about 100 μm. However, this is for illustrative purposes, and the thickness TO of the adhesive member AP is not limited thereto.

In an embodiment, the adhesive member AP may have a 180° peel force of about 800 gf/25 mm or greater at about 25° C. for at least one of a glass substrate or a polymer substrate. As used herein, a 180° peel force refers to the peel force measured according to the JIS Z0237 standard. The temperature of about 25° C. may be room temperature. An adhesive member having a 180° peel force of less than about 800 gf/25 mm for a glass substrate and a polymer substrate, has low adhesion and is peeled off from components such as the display module DM and the window WP. In embodiments, the adhesive member having a 180° peel force of about 800 gf/25 mm or greater for a glass substrate and a polymer substrate at about 25° C., according to an embodiment, may exhibit excellent adhesion. In embodiments, the display device DD including the adhesive member AP according to an embodiment may exhibit excellent reliability.

In an embodiment, the adhesive member AP may have a transmittance for light having a wavelength of about 400 nm may be about 0% or greater and less than about 5%. The adhesive member AP having the transmittance of about 0% or greater and less than about 5% for light having a wavelength of about 400 nm may prevent or reduce deterioration of the light emitting element ED (FIG. 4) due to external light (for example, ultraviolet light). The light having a wavelength of about 400 nm may correspond to ultraviolet light. The adhesive member AP may have a transmittance of about 85% to about 99% for light having a wavelength of about 450 nm. The adhesive member AP having the transmittance of about 85% to about 99% for light having a wavelength of about 450 nm may not block the transmission of blue light and may transmit light emitted from the light-emitting element ED (FIG. 4). The light having a wavelength of about 450 nm may correspond to visible light. Because the transmittance of the adhesive member AP according to an embodiment falls within the above-described transmittance range in a wavelength range of about 400 nm to about 450 nm, deterioration of the light-emitting element ED (FIG. 4) may be prevented or reduced and the adhesive member AP may have an excellent transmittance for visible light emitted from the light-emitting element ED (FIG. 4). The adhesive member AP may exhibit excellent ultraviolet blocking rate and excellent visible light transmittance.

The display device DD according to an embodiment may include no polarizer. The display device including a polarizer has reduced luminance, and thus has degraded display quality, and has an increased thickness. In the display device including no polarizer, the light-emitting element deteriorates due to external light, and a lifespan thereof decreases. In embodiments, the display device DD according to an embodiment includes no polarizer, thus may maintain display quality, and may be provided in a thin thickness. In embodiments, the display device DD according to an embodiment includes no polarizer but includes the adhesive member AP that has a transmittance falling within the above-described range for light in a wavelength region of about 400 nm to about 450 nm, thereby exhibiting excellent display quality and display lifespan.

FIG. 4 is a cross-sectional view illustrating an example embodiment of the display module DM in FIG. 3. Configurations of the display module DM illustrated in FIG. 4 are shown for illustrative purposes, but an embodiment of the present disclosure is not limited thereto.

In FIG. 4, the base substrate BS may include a single layer or multilayers. For example, the base substrate BS may include a first synthetic resin layer, a multi- or single-layered inorganic layer, and a second synthetic resin layer on the multi- or single-layered inorganic layer. The first synthetic resin layer and the second synthetic resin layer may each include a polyimide-based resin. In embodiments, the first synthetic resin layer and the second synthetic resin layer may include at least one of an acryl-based resin, a methacryl-based resin, a polyisoprene-based resin, a vinyl-based resin, an epoxy-based resin, a urethane-based resin, a cellulose-based resin, a siloxane-based resin, a polyamide-based resin, or a perylene-based resin. As used herein, the term “˜-based” resin refers to a resin including a “˜-based” functional group.

The display panel DP may include a transistor TR and a light-emitting element ED. The transistor TR and the light-emitting element ED may be on the base substrate BS. In FIG. 4, although one transistor TR is illustrated, the display panel DP may substantially include a plurality of transistors and at least one capacitor for driving the light-emitting element ED.

The circuit layer DP-CL may be on the base substrate BS. The circuit layer DP-CL may include a blocking electrode BML, a transistor TR, a connection electrode CNE, and a plurality of insulation layers BFL and INS1 to INS6. The plurality of insulation layers BFL and INS1 to INS6 may include a buffer layer BFL and a first to sixth insulation layers INS1 to INS6. However, a stacked structure of the circuit layer DP-CL illustrated in FIG. 4 is shown for illustrative purposes, and the stacked structure of the circuit layer DP-CL may vary depending on configurations of the display panel DP and processes of the circuit layer DP-CL and/or the like.

The blocking electrode BML may be on the base substrate BS. The blocking electrode BML may overlap the transistor TR. The blocking electrode BML may protect the transistor TR by blocking or reducing transmission of incident light from below the display panel DP to the transistor TR. The blocking electrode BML may include a conductive material. When a voltage is applied to the blocking electrode BML, a threshold voltage of the transistor TR on the blocking electrode BML may be maintained. However, an embodiment of the present disclosure is not limited thereto, and the blocking electrode BML may be a floating electrode. In embodiments, the blocking electrode BML may be omitted.

The buffer layer BFL that is on the base substrate BS may cover the blocking electrode BML. The buffer layer BFL may include an inorganic layer. The buffer layer BFL may improve adhesion between the base substrate BS and a semiconductor pattern or a conductive pattern, which are on the buffer layer BFL.

The transistor TR may include a source S1, a channel C1, a drain D1, and a gate G1. The source S1, the channel C1, and the drain D1 of the transistor TR may be formed from a semiconductor pattern. The semiconductor pattern of the transistor TR may include polysilicon, amorphous silicon, and/or metal oxide. Any suitable material that has semiconductor properties may be applied without limitation, but is not limited to anyone.

The semiconductor pattern may include a plurality of regions that are distinguished by conductivity thereof. A region of the semiconductor patterns doped with a dopant or reduced with a metal oxide may have large conductivity, or may substantially serve as a source electrode and a drain electrode of the transistor TR.

The region of the semiconductor patterns, which has large conductivity, may correspond to the source S1 and the drain D1 of the transistor TR. A region of the semiconductor patterns, which is undoped, doped at a low concentration, or unreduced with a metal oxide, and thus has low conductivity, may correspond to a channel C1 (or active region) of the transistor TR.

The first insulation layer INS1 may be on the buffer layer BFL while covering a semiconductor pattern. A gate G1 of the transistor TR may be on the first insulation layer INS1. On a plane, the gate G1 may overlap the channel C1 of the transistor TR. The gate G1 may function as a mask in a doping process of the semiconductor pattern.

The second insulation layer INS2 may be on the first insulation layer INS1 while covering the gate G1. The third insulation layer INS3 may be on the second insulation layer INS2.

The connection electrode CNE may include a first connection electrode CNE1 and a second connection electrode CNE2 for an electrical connection of the transistor TR and the light-emitting element ED. However, configurations of the connection electrode CNE, which makes the transistor TR and the light-emitting element ED electrically connected, are not limited thereto. One among the first and the second connection electrodes CNE1 and CNE2 may be omitted, or an additional connection electrode may be further included.

The first connection electrode CNE1 may be on the third insulation layer INS3. The first connection electrode CNE1 may be connected to the drain D1 through a first contact hole CH1 penetrating the first to the third insulation layers INS1 to INS3. The fourth insulation layer INS4 may be on the third insulation layer INS3 while covering the first connection electrode CNE1. The fifth insulation layer INS5 may be on the fourth insulation layer INS4.

The second connection electrode CNE2 may be on the fifth insulation layer INS5. The second connection electrode CNE2 may be connected to the first connection electrode CNE1 through a second contact hole CH2 penetrating the fourth and the fifth insulation layers INS4 and INS5. The sixth insulation layer INS6 may be on the fifth insulation layer INS5 while covering the second connection electrode CNE2.

The first to sixth insulation layers INS1 to INS6 may each include an inorganic layer and/or an organic layer. For example, the inorganic layer may contain at least one among aluminum oxide, titanium oxide, silicon oxide, silicon oxynitride, zirconium oxide, and hafnium oxide. The organic layer may include at least one among an acryl-based resin, a methacryl-based resin, a polyisoprene-based resin, a vinyl-based resin, an epoxy-based resin, a urethane-based resin, a cellulose-based resin, a siloxane-based resin, a polyamide-based resin, and a perylene-based resin.

The display element layer DP-EL may include a pixel definition film PDL and a light-emitting element ED. The light-emitting element ED may include a first electrode AE, a hole control layer HCL, an emission layer EML, an electron control layer TCL, and a second electrode CE.

The first electrode AE may be on the sixth insulation layer INS6. The first electrode AE may be connected to the second connection electrode CNE2 through a third contact hole CH3 penetrating the sixth insulation layer INS6. The first electrode AE may be electrically connected to the drain D1 of the transistor TR through the first and second connection electrodes CNE1 and CNE2.

The first electrode AE may be made of a metal material, a metal alloy, and/or a conductive compound. The first electrode AE may be an anode or a cathode. However, an embodiment of the present disclosure is not limited thereto. In embodiments, the first electrode AE may be a pixel electrode. The first electrode AE may be a transmissive electrode, a transflective electrode, or a reflective electrode. The first electrode AE may include: at least one selected from among Ag, Mg, Cu, Al, Pt, Pd, Au, Ni, Nd, Ir, Cr, Li, Ca, LiF, Mo, Ti, W, In, Sn, and Zn; a compound of two or more selected therefrom; a mixture of two or more selected therefrom; and an oxide thereof.

When the first electrode AE is a transmissive electrode, the first electrode AE may include a transparent metal oxide such as indium tin oxide (ITO), indium zinc oxide (IZO), zinc oxide (ZnO), indium tin zinc oxide (ITZO). When the first electrode AE is a transflective electrode or a reflective electrode, the first electrode AE may include Ag, Mg, Cu, Al, Pt, Pd, Au, Ni, Nd, Ir, Cr, Li, Ca, LiF/Ca (a stacked structure of LiF and Ca), LiF/Al (a stacked structure of LiF and Al), Mo, Ti, W, or a mixture or compound thereof (for example, a mixture of Ag and Mg). In embodiments, the first electrode AE may have a multilayered structure including a reflective film or transflective film made of the above-described materials, and a transparent conductive film formed of indium tin oxide (ITO), indium zinc oxide (IZO), zinc oxide (ZnO), indium tin zinc oxide (ITZO), etc. For example, the first electrode AE may have a three-layered stricture of ITO/Ag/ITO, but is not limited thereto. Embodiments of the present disclosure are not limited thereto, however, and the first electrode AE may include the above-described metal materials, a combination of two or more metal materials selected from the above-described metal materials, oxides of the above-described metal materials, etc.

The pixel definition film PDL may be on the sixth insulation layer INS6. In the pixel definition film PDL, an emission opening part PX_OP exposing a portion of the first electrode AE may be defined. The portion of the first electrode AE exposed by the emission opening part PX_OP may be defined as an emission region LA.

An active region AA-DM of the display module DM may include an emission region LA and a light-blocking region NLA. A region in which the pixel definition film PDL is provided may correspond to the light-blocking region NLA. The light-blocking region NLA may surround the emission region LA in the active region AA-DM.

The hole control layer HCL may be on the first electrode AE and the pixel definition film PDL. The hole control layer HCL may be provided as a common layer overlapping the emission region LA and the light-blocking region NLA. The hole control layer HCL may include at least one among a hole transport layer, a hole injection layer, and an electron blocking layer. The hole control layer HCL may include any suitable hole injection materials generally used in the art and/or any suitable hole transport materials generally used in the art.

The emission layer EML may be on the hole control layer HCL. The emission layer EML may be provided in a region corresponding to the emission opening part PX_OP. In embodiments, the emission layer EML may be provided as a common layer. The emission layer EML may include organic emission materials and/or inorganic emission materials. The emission layer EML may emit any one color light among red, green, and blue. For example, the emission layer EML may emit blue light.

The electron control layer TCL may be on the emission layer EML. The electron control layer TCL may be provided as a common layer overlapping the emission region LA and the light-blocking region NLA. The electron control layer TCL may include at least one among an electron transport layer, an electron injection layer, and a hole blocking layer. The electron control layer TCL may include any suitable electron injection materials generally used in the art and/or any suitable electron transport materials generally used in the art.

The second electrode CE may be on the electron control layer TCL. The second electrode CE may be provided as a common layer overlapping the emission region LA and the light-blocking region NLA.

The second electrode CE may be a common electrode. The second electrode CE may be a cathode or an anode, but an embodiment of the present disclosure is not limited thereto. For example, when the first electrode AE is an anode, the second electrode CE may be a cathode, and when the first electrode AE is a cathode, the second electrode CE may be an anode.

The second electrode CE may be a transmissive electrode, a transflective electrode, or a reflective electrode. When the second electrode CE is a transmissive electrode, the second electrode CE may be made of a transparent metal oxide such as indium tin oxide (ITO), indium zinc oxide (IZO), zinc oxide (ZnO), and/or indium tin zinc oxide (ITZO).

When the second electrode CE is a transflective electrode, or a reflective electrode, the second electrode CE may contain Ag, Mg, Cu, Al, Pt, Pd, Au, Ni, Nd, Ir, Cr, Li, Ca, LiF/Ca, LiF/Al, Mo, Ti, Yb, W, or a compound or mixture containing the same (for example, AgMg, AgYb, and/or MgYb). In embodiments, the second electrode CE may have a multilayered structure including a reflective film or a transflective film, formed of the above-described materials and a transparent conductive film formed of indium tin oxide (ITO), indium zinc oxide (IZO), zinc oxide (ZnO), indium tin zinc oxide (ITZO), etc. For example, the second electrode CE may include the above-described metal materials, combinations of two or more metal materials selected from the above-described metal materials, oxides of the above-described metal materials, etc.

The encapsulation layer TFE may be on the second electrode CE to cover the light-emitting element ED. The encapsulation layer TFE may include a plurality of thin films. For example, the encapsulation layer TFE may include inorganic layers on the second electrode CE and organic films between the inorganic films. The inorganic film may protect the light-emitting element ED from moisture/oxygen, and the organic film may protect the light-emitting element ED from foreign materials such as, for example, dust particles.

The input-sensing part TP may include a first sensing insulation layer IL1, a second sensing insulation layer IL2, a third sensing insulation layer IL3. The input-sensing part TP may include at least one conductive layer on the sensing insulation layers. The input-sensing part TP may include a first conductive layer CDL1 and a second conductive layer CDL2.

The first sensing insulation layer IL1 may be on the encapsulation layer TFE. The first sensing insulation layer IL1 may include at least one inorganic insulation layer. The first sensing insulation layer IL1 may contact the encapsulation layer TFE. In embodiments, the first sensing insulation layer IL1 may be omitted, and in this case, the first conductive layer CDL1 may contact (e.g., physically contact) the encapsulation layer TFE.

The first conductive layer CDL1 may be on the first sensing insulation layer IL1. The first conductive layer CDL1 may include a plurality of first conductive patterns. The plurality of first conductive patterns may be on the first sensing insulation layer IL1. The second sensing insulation layer IL2 may be on the first sensing insulation layer IL1 so as to cover at least a portion of the first conductive layer CDL1.

The second conductive layer CDL2 may be on the second sensing insulation layer IL2. The second conductive layer CDL2 may include a plurality of second conductive patterns. The plurality of second conductive patterns may be on the second sensing insulation layer IL2. Each of the plurality of second conductive patterns may contact the plurality of first conductive patterns through the contact hole formed on the second sensing insulation layer IL2.

The plurality of the first conductive patterns of the first conductive layer CDL1 and the plurality of the second conductive patterns of the second conductive layer CDL2 may each correspond to the light-blocking region NLA. The plurality of the first conductive patterns of the first conductive layer CDL1 and the plurality of the second conductive patterns of the second conductive layer CDL2 may each correspond to a mesh pattern.

The third sensing insulation layer IL3 may be on the second sensing insulation layer IL2, and may cover the second conductive layer CDL2. The second sensing insulation layer IL2 and the third sensing insulation layer IL3 may each include an inorganic insulation layer and/or an organic insulation layer.

The first conductive layer CDL1 and the second conductive layer CDL2 may each have a single-layered structure or may each have a multilayered structure stacked along a third direction DR3. The conductive layers CDL1 and CDL2 of the single-layered structure may include a metal layer and/or a transparent conductive layer. The metal layer may include molybdenum, silver, titanium, copper, aluminum, and/or an alloy thereof. The transparent conductive layer may include a transparent conductive oxide such as indium tin oxide, (ITO), indium zinc oxide (IZO), zinc oxide (ZnO), and/or indium zinc tin oxide (IZTO). In embodiments, the transparent conductive layer may include a transparent polymer such as PEDOT, metal nanowires, graphene, etc.

The conductive layers CDL1 and CDL2 having a multilayered structure may include metal layers. The metal layers may have, for example, a three-layered structure of titanium (Ti)/aluminum (Al)/titanium (Ti). The conductive layers CDL1 and CDL2 having a multilayered structure may include at least one metal layer and at least one transparent conductive layer.

FIG. 5A to FIG. 5D are views schematically showing a method of manufacturing an adhesive member AP from the resin composition RC according to an embodiment. For example, the method of manufacturing an adhesive member AP may include: providing a resin composition RC on a substrate CF; providing a first light UV-1 to the resin composition RC to form a preliminary adhesive member P-AP; and providing a second light UV-2 to the preliminary adhesive member P-AP to form an adhesive member AP (see, e.g., FIG. 3). Hereinafter, in descriptions of FIG. 5A to FIG. 5D, duplicated contents with the descriptions with reference to FIG. 1 to FIG. 4 are not explained again, and differences will be mainly described.

Referring to FIG. 5A, the resin composition RC according to an embodiment may be provided on the substrate CF. The resin composition RC may be provided on the substrate CF through a nozzle NZ. For example, the substrate CF on which the resin composition RC is provided may include polyethylene terephthalate (PET). The substrate CF may be a temporary substrate that is used for forming the adhesive member AP (FIG. 3) from the resin composition RC, and any suitable substrate may be used without limitation as long as the resin composition RC (or the preliminary adhesive member P-AP or the adhesive member AP) may be easily removed therefrom after curing. One surface of the substrate CF on which the resin composition RC is provided may be release treated.

In an embodiment, the resin composition RC including a dihydroxybenzophenone ultraviolet absorber, a photoinitiator that absorbs light having a wavelength of about 400 nm to about 450 nm, a monofunctional (meth)acrylate monomer, and a (meth)acrylate oligomer may be provided by an inkjet printing method and/or a dispensing method. The liquid resin composition RC may be provided in a uniform (or substantially uniform) amount and/or at a uniform (or substantially uniform) rate. In FIG. 5A, the resin composition RC is illustrated to be provided through the nozzle NZ, and a device that provides the resin composition RC is not limited thereto.

The resin composition RC according to an embodiment may include a dihydroxybenzophenone-based ultraviolet absorber, a photoinitiator that absorbs light having a wavelength of about 400 nm to about 450 nm, at least one monofunctional (meth)acrylate monomer, and at least one (meth)acrylate oligomer. As used herein, the (meth)acryloyl group means an acryloyl group or a methacryloyl group, and (meth)acryl means acryl or methacryl.

Because the resin composition RC includes the ultraviolet absorber, the adhesive member AP (FIG. 3) formed by curing the resin composition RC may have a transmittance that falls within the above-described range (about 0% or greater and less than about 5%) for light having a wavelength of about 400 nm. The dihydroxybenzophenone-based ultraviolet absorber may include a dihydroxybenzophenone functional group. The dihydroxybenzophenone-based ultraviolet absorber may include 2,2′,4,4′-tetrahydroxybenzophenone (CAS: 131-55-5).

The dihydroxybenzophenone-based ultraviolet absorber may have a weight of about 2 wt % to about 10 wt % with respect to 100 wt % of the total weight of the resin composition RC. The adhesive member formed from the resin composition including the dihydroxybenzophenone-based ultraviolet absorber, of which a weight is less than about 2 wt % with respect to 100 w % of the total weight of the resin composition, does not have a transmittance falling within the above-described range for light having a wavelength of about 400 nm. Therefore, display quality and display lifespan of the display device decrease if the dihydroxybenzophenone-based ultraviolet absorber is included in an amount less than the above range. It is not easy to cure the resin composition, in which the weight of the dihydroxybenzophenone-based ultraviolet absorber exceeds about 10 wt % with respect to 100% of the total weight of the resin composition, and thus the adhesive member may not be formed if the dihydroxybenzophenone-based ultraviolet absorber is included in an amount greater than the above range. The resin composition is cured when ultraviolet light is provided to form an adhesive member. If the weight of the ultraviolet absorber is too large (e.g., more than about 10 wt % with respect to 100% of the total weight of the resin composition), ultraviolet light provided for curing the resin composition is absorbed, so that the adhesive member may not be formed. In embodiments, the resin composition RC including the dihydroxybenzophenone-based ultraviolet absorber, of which the weight is about 2 wt % to about 10 wt % with respect to 100 wt % of the total weight of the resin composition RC, may show characteristics of easy curing when ultraviolet light is provided. In embodiments, the resin composition RC including the dihydroxybenzophenone-based ultraviolet absorber, of which the weight is about 2 wt % to about 10 wt % with respect to 100 wt % of the total weight of the resin composition RC, may form an adhesive member AP which has a transmittance that falls within the above-described range for light having a wavelength of about 400 nm.

The resin composition RC may include a photoinitiator that absorbs light in a wavelength region of about 400 nm to about 450 nm. When light in the wavelength region of about 400 nm to about 450 nm is provided, the photoinitiator of the resin composition RC may be activated. When the resin composition RC includes the photoinitiator that absorbs light in a wavelength region of less than 400 nm, it is not easy to cure the resin composition RC, and the resin composition is not cured enough to form the adhesive member. When the resin composition RC includes the photoinitiator that absorbs light in a wavelength region of greater than about 450 nm, discoloration occurs in the adhesive member formed by curing the resin composition RC. The resin composition RC according to an embodiment includes the photoinitiator that absorbs light in a wavelength region of about 400 nm to about 450 nm, thus adhesion after curing may be excellent, and optically transparent properties may be shown. The adhesive member AP formed from the resin composition RC including the photoinitiator absorbing light in a wavelength region of about 400 nm to about 450 nm may have excellent adhesion and exhibit optically transparent properties. In the resin composition RC, the photoinitiator may include bis(2,4,6-trimethylbenzoyl)phenyl phosphine oxide (CAS: 162881-26-7).

The resin composition RC may include a plurality of photoinitiators. When the resin composition RC includes a plurality of photoinitiators, different photoinitiators may be activated due to ultraviolet having different peak wavelengths.

For example, the photoinitiator may further include at least one among 2,2-dimethoxy-1,2-diphenylethan-1-one, 1-hydroxy-cyclohexyl-phenyl-ketone, 2-hydroxy-2-methyl-1-phenyl-1-propanone, 2-hydroxy-1-[4-(2-hydroxyethoxy)phenyl]-2-methyl-1-propanone, and 2-hydroxy-1-{4-[4-(2-hydroxy-2-methyl-propionyl)-benzyl]-phenyl}-2-methylpropan-1-one.

In embodiments, the photoinitiator may further include at least one among 2-methyl-1 [4-(methylthio)phenyl]-2-morpholinopropan-1-one), 2-benzyl-2-dimethylamino-1-(4-morpholinophenyl)-butanone-1,2-dimethylamino-2-(4-methyl-benzyl)-1-(4-morpholin-4-yl-phenyl)-butan-1-one, 2,4,6-trimethylbenzoyl-diphenylphosphine oxide, ethyl(2,4,6-trimethylbenzoyl)phenyl phosphinate, phenylbis(2,4,6-trimethylbenzoyl) phosphine oxide, [1-(4-phenylsulfanylbenzoyl) heptylideneamino]benzoate, [1-[9-ethyl-6-(2-methylbenzoyl) carbazol-3-yl]ethylideneamino] acetate, and bis(2,4-cyclopentadienyl)bis [2,6-difluoro-3-(1-pyrryl)phenyl] titanium (IV).

The resin composition RC may include at least one monofunctional (meth)acrylate monomer. In the resin composition RC, the monofunctional (meth)acrylate monomer may include 4-hydroxybutyl acrylate (4-HBA), 2-ethylhexyl acrylate (2-EHA), tetrahydrofurfuryl acrylate (THF-A), and 2-ethylhexyl-diglycol acrylate (EHDG-AT). However, this is shown for illustrative purposes, but the resin composition RC may further include a monofunctional (meth)acrylate monomer in addition to the above-described monomers.

The weight of the monofunctional (meth)acrylate monomer may be about 75 wt % to about 85 wt % with respect to 100 wt % of the total weight of the resin composition RC. The resin composition RC including a monofunctional (meth)acrylate monomer, of which the weight is about 75 wt % to about 85 wt % with respect to 100 wt % of the total weight of the resin composition RC, may be provided through an inkjet printing method and/or a dispensing method, and thus suitable characteristics may be exhibited. In embodiments, the adhesive member AP formed from the resin composition RC including the monofunctional (meth)acrylate monomer of which the weight is about 75 wt % to about 85 wt % with respect to 100 wt % of the total weight of the resin composition RC may exhibit excellent adhesion.

For example, the resin composition RC may include a monofunctional (meth)acrylate monomer having a weight-average molecular weight of about 100 to about 500. However, this is shown for illustrative purposes, but the molecular weight of the monofunctional (meth)acrylate monomer included in the resin composition RC is not limited thereto.

The resin composition RC may include at least one (meth)acrylate oligomer. The weight-average molecular weight of the (meth)acrylate oligomer may be about 5,000 to about 40,000. The (meth)acrylate oligomer having the weight-average molecular weight of about 5,000 to about 40,000 may be included in the resin composition RC in an oligomer state having a relatively high degree of polymerization, thereby maintaining a high degree of polymerization after photocuring, and thus the adhesive member AP having excellent adhesion may be formed.

For example, the weight of the (meth)acylate oligomer may be about 10 wt % to about 20 wt % with respect to the 100 wt % of the total weight of the resin composition RC. However, this is merely an example, but the weight of the (meth)acrylate oligomer is not limited thereto.

For example, in the resin composition RC, the (meth)acrylate oligomer may include a urethane (meth)acrylate oligomer. In the resin composition RC, the (meth)acrylate oligomer may include at least one among urethane acrylate (UF-C051, a product of Kyoeisha Chemical Co., Ltd), urethane acrylate (UF-C052, a product of Kyoeisha Chemical Co., Ltd) and urethane acrylate (UN6304, a product of Negami Chemical Industrial Co., Ltd). However, these are merely examples, but the (meth)acrylate oligomer included in the resin composition RC is not limited thereto.

Referring to FIG. 5B, the first light UV-1 may be provided to the resin composition RC applied to the substrate CF in a constant (or substantially constant) thickness. The liquid resin composition RC is cured due to the first light UV-1 to form a preliminary adhesive member P-AP (FIG. 5C). The first light UV-1 may be ultraviolet light. In FIG. 5B, the first light UV-1 is illustrated to be directly irradiated to the resin composition RC applied to the substrate CF to form the preliminary adhesive member P-AP, but an embodiment of the present disclosure is not limited thereto. A carrier film may be on the resin composition RC applied in a uniform (or substantially uniform) thickness, and the carrier film may transmit ultraviolet light.

Referring to FIG. 5C and FIG. 5D, the preliminary adhesive member P-AP formed from the resin composition RC by irradiating the first light UV-1 (FIG. 5B) may be separated from the substrate CF, and may be provided on one side of the window WP or one side of the display module DM. One surface of the preliminary adhesive member P-AP is laminated on one side of the window WP or one side of the display module DM, and another side of the window WP or another side of the display module DM, which is not attached, may be attached. Thereafter, the second light UV-2 is irradiated to the preliminary adhesive member P-AP to form the adhesive member AP (FIG. 3). The second light UV-2 may be ultraviolet light. The second light UV-2 may be provided on the top of the window WP, and the window WP may transmit the second light UV-2. The second light UV-2 may pass through the window WP, thereby being capable of being provided to the preliminary adhesive member P-AP.

The resin composition RC according to an embodiment after curing due to the light UV-1 and UV-2 may have a 180° peel force of about 800 gf/25 mm or greater for at least one among a glass substrate and a polymer substrate. Therefore, the resin composition RC according to an embodiment after curing may exhibit excellent adhesion.

The resin composition RC according to an embodiment may have a transmittance of about 0% or greater, and less than about 5% for light having a wavelength of about 400 nm and may have a transmittance of about 85% to about 99% for light having a wavelength of about 450 nm. Therefore, the resin composition RC according to an embodiment may exhibit an excellent ultraviolet light shielding rate and excellent transmittance for visible light after curing.

In FIG. 5A to FIG. 5D, the resin composition RC is shown to be cured twice (e.g., cured by providing light twice), to thereby form the adhesive member AP (FIG. 3), but an embodiment of the present disclosure is not limited thereto. For example, the resin composition RC may be cured once to form the adhesive member AP (FIG. 3) or may be cured three or more times to form the adhesive member AP (FIG. 3).

FIG. 6A to FIG. 6C are views schematically illustrating another method of manufacturing the adhesive member AP from the resin composition RC according to an embodiment. Hereinafter, in descriptions of FIG. 6A to FIG. 6C, duplicated contents described with reference to FIG. 1 to FIG. 5D will not be explained again, and differences will be mainly explained.

The method of manufacturing the adhesive member AP shown in FIG. 6A to FIG. 6C may include: providing the resin composition RC to the display module DM; providing the first light UV-1 to the resin composition RC to form the preliminary adhesive member P-AP; and providing the second light UV-2 to the preliminary adhesive member P-AP to form the adhesive member AP (see, e.g., FIG. 3). The method shown in FIG. 6A to FIG. 6C, compared to the method shown in FIG. 5A to FIG. 5D, has a difference in that the resin composition RC is provided on the display module DM.

The resin composition RC may be directly provided on one surface of the display module DM or one surface of the window WP. FIG. 6A, illustrates that the resin composition RC is directly provided on one surface of the display module DM.

Referring to FIG. 6D, the first light UV-1 may be provided to the uniformly (or substantially uniformly) applied resin composition. Since the first light UV-1 is provided to the resin composition RC, the preliminary adhesive member P-AP may be formed. The window WP may be provided on the preliminary adhesive member P-AP. Referring to FIG. 6C, the second light UV-2 may pass through the window WP, thereby being capable of being provided to the preliminary adhesive member P-AP. The preliminary adhesive member P-AP may be cured due to the second light UV-2, so that the adhesive member AP (FIG. 3) may be formed.

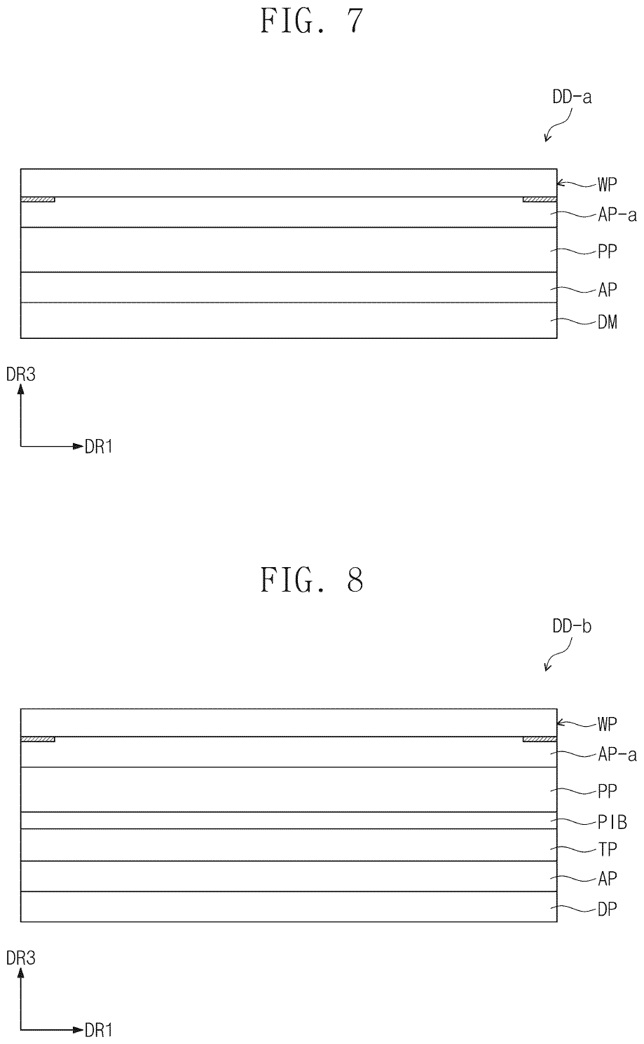

FIG. 7 is a cross-sectional view illustrating a display device according to an embodiment of the present disclosure. Hereinafter, in descriptions of the display device illustrated in FIG. 7, duplicated contents described with reference to FIG. 1 to FIG. 6C will not be explained again, and differences will be mainly explained.

Compared to the display device described with reference to FIG. 2 and FIG. 3, a display device DD-a illustrated in FIG. 7 may further include a light control layer PP and an optical adhesive layer AP-a. The display device DD-a according to an embodiment may further include the light control layer PP between the adhesive member AP and the window WP, and the optical adhesive layer AP-a between the light control layer PP and the window WP. The light control layer PP may include no polarizer (e.g., the control layer PP may not include a polarizer, a polarizer may not be present in the control layer PP, or the control layer PP may be free of a polarizer). The light control layer PP may include a color filter layer.

The optical adhesive layer AP-a may be formed from the resin composition RC according to an embodiment. The optical adhesive layer AP-a including a polymer derived from the resin composition RC may have a 180° peel force of about 1,000 gf/25 mm or greater for at least one among a glass substrate and a polymer substrate at about 25° C. The optical adhesive layer AP-a including the polymer derived from the resin composition RC may have a transmittance of about 0% or greater and less than about 5% for light having a wavelength of about 400 nm and a transmittance of about 85% to about 99% for light having a wavelength of about 450 nm. Therefore, the optical adhesive layer AP-a including the polymer derived from the resin composition RC may exhibit excellent adhesion, excellent ultraviolet shielding rate, and excellent transmittance for visible light. The display device DD including the optical adhesive layer AP-a may exhibit excellent reliability, excellent display lifespan, and excellent display quality.

FIG. 8 is a cross-sectional view illustrating a display device according to an embodiment of the present disclosure. Hereinafter, in descriptions of the display device illustrated in FIG. 8, duplicated contents described with reference to FIG. 1 to FIG. 7 will not be explained again, and differences will be mainly explained.

The display device DD-b according to an embodiment, illustrated in FIG. 8, compared the display device DD described with reference FIG. 2 and FIG. 3, may further include a light control layer PP, an optical adhesive layer AP-a, and an interlayer adhesive layer PIB. The display device DD-b according to an embodiment, illustrated in FIG. 8 may further include a light control layer PP between the adhesive member AP and the window WP, and an optical adhesive layer AP-a between the light control layer PP and the window WP similar to the display device DD-a according to an embodiment, illustrated in FIG. 7.

In the display device DD-b according to an embodiment, the adhesive member AP may be provided between the display panel DP and the input-sensing part TP. For example, the input-sensing part TP may not be directly on the display panel DP, and the display panel DP and the input-sensing part TP may be connected to each other by the adhesive member AP. For example, the adhesive member AP may be between the encapsulation layer TFE (FIG. 3) and the input-sensing part TP of the display panel DP.

The interlayer adhesive layer PIB may be provided below the light control layer PP. The interlayer adhesive layer PIB may be between the input-sensing part TP and the light control layer PP, and may be formed of adhesive materials having excellent moisture permeability prevention or reduction. For example, the interlayer adhesive layer PIB may be formed from polyisobutylene. The interlayer adhesive layer PIB may be on the input-sensing part TP, and thus corrosion of sensing electrodes of the input-sensing part TP may be prevented or reduced. The display device DD-b according to an embodiment may include the optical adhesive layer AP-a and the adhesive member AP, formed from the resin composition RC according to an embodiment, and the display device DD-b including the optical adhesive layer AP-a and the adhesive member AP may exhibit excellent reliability.

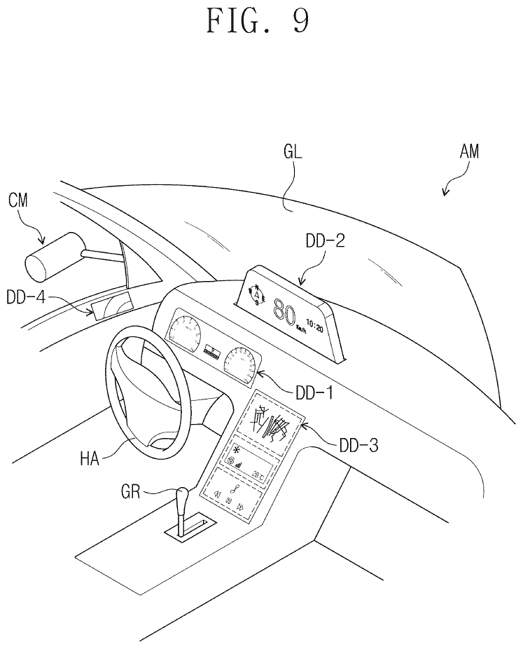

FIG. 9 is a view illustrating a vehicle AM in which first to fourth display devices DD-1, DD-2, DD-3, and DD-4 are provided. At least one among the first to fourth display devices DD-1, DD-2, DD-3, and DD-4 may include the same configuration as any one among the display devices DD, DD-a, and DD-b, described with reference to FIG. 1, FIG. 3, and FIG. 7 and FIG. 8. At least one among the first to fourth display devices DD-1, DD-2, DD-3, and DD-4 may include the adhesive member AP according to an embodiment, described with reference to FIG. 1 to FIG. 3, FIG. 7, and FIG. 8.

In FIG. 9, a car is illustrated as the vehicle AM, but this is shown as an example, and the first to fourth display devices DD-1, DD-2, DD-3, and DD-4 may be provided in other means for transport such as bicycles, motorcycles, trains, ships, and/or airplanes. In embodiments, at least one among the first to fourth display devices DD-1, DD-2, DD-3, and DD-4 similarly including the configuration of any one among the display devices DD, DD-a, and DD-b according to an embodiment may be employed to other electronic devices as long as it does not depart from the scope of present disclosure.

At least one among the first to fourth display devices DD-1, DD-2, DD-3, and DD-4 may include the adhesive member AP according to an embodiment. The adhesive member AP according to an embodiment may be formed from the resin composition RC according to an embodiment, thereby exhibiting excellent adhesion, excellent ultraviolet light shielding rate, and excellent transmittance for visible light.

The adhesive member AP may have a 180° peel force of about 800 gf/25 mm or greater for at least one among a glass substrate and a polymer substrate. The adhesive member AP may have a transmittance of about 0% or greater and less than about 5% for light having a wavelength of about 400 nm and may have a transmittance of about 85% to about 99% for light having a wavelength of about 450 nm. Therefore, the display device, among the first to fourth display devices DD-1, DD-2, DD-3, and DD-4, including the adhesive member AP according to an embodiment may exhibit excellent reliability, excellent display lifespan, and excellent display quality.

Referring to FIG. 9, the vehicle AM may include a handle HA (e.g., a steering wheel HA), and a gear GR (e.g., a gear shifter) for operating the vehicle AM, and a front window GL may face a driver.

The first display device DD-1 may be in a first region overlapping the handle HA. For example, the first display device DD-1 may be a digital cluster that displays a first information of the vehicle AM. The first information of the vehicle AM may include a first scale that displays a driving speed of the vehicle AM, a second scale that displays an engine speed (e.g., revolutions per minute (RPM)), an image that displays a fuel gauge, etc. The first scale and the second scale may be displayed as digital images.

The second display device DD-2 may be in a second region facing a driving seat, and overlapping the front window GL. The driving seat may be a seat in front of which the handle HA is provided. For example, the second display device DD-2 may be a heads up display (HUD) that displays a second information of the vehicle AM. The second display device DD-2 may be optically transparent. The second information may include digital numbers that show the driving speed of the vehicle AM and may further include information such as the current time. In embodiments, the second information of the second display device DD-2 may be displayed by projecting on the front window GL.

The third display device DD-3 may be in a third region adjacent to the gear GR. For example, the third display device DD-3 may be a center information display (CID) for a vehicle, which is between the driving seat and a passenger seat and displays a third information. The passenger seat may be a seat spaced apart from the driving seat with the gear GR therebetween. The third information may include information about road conditions (for example, navigation information), the playback of music or radio, the playback of dynamic images (or images), the temperature inside the vehicle AM, and/or the like.

The fourth display device DD-4 may be in a fourth region spaced apart from the handle HA and the gear GR, and adjacent to a side of the vehicle AM. For example, the fourth display device DD-4 may be a digital side mirror that displays a fourth information. The fourth display device DD-4 may display an image of the exterior of the vehicle AM captured by a camera module CM outside the vehicle AM.

The fourth information may include the image of the exterior of the vehicle AM. The above-described first to fourth information are for illustrative purposes, and the first to fourth display devices DD-1, DD-2, DD-3, and DD-4 may display more or less information about the interior and exterior of the vehicle. The first to fourth information may include different information from each other. However, an embodiment of the present disclosure is not limited thereto, and a portion of the first to fourth information may include the same information as each other.

Hereinafter, with reference to Examples and Comparative Examples, the resin composition according to an embodiment of the present disclosure and the adhesive member formed from the resin composition will be described in more detail. In addition, Examples, which will be further described below, are embodiments to aid understanding of the present disclosure, and the scope of the present disclosure is not limited thereto.

### EXAMPLES

### 1. Manufacture of Resin Composition

The resin compositions according to the Examples and Comparative Examples were manufactured from the materials listed in Table 1. The listed materials in Table 1, in each amount (g, gram), were provided in a light-blocking polymer container. Thereafter, the materials were stirred at room temperature for uniform mixing to thereby manufacture the resin compositions according to the Examples and Comparative Examples. The resin compositions according to Comparative Examples 6 and 7, in Table, 1, correspond to Adhesive Compositions No. 1, and No. 2 in Table 1 of Patent document KR 10-2021-0116446. Tinuvin 477 is a mixture, in which 80% of the mixture is a UV absorber (a structure thereof is not disclosed) including hydroxyphenyl-triazine, and 20% of the mixture is CAS 108-65-5, which is a solvent component.

TABLE 1

| | | | | Compar- | Compar- | Compar- | Compar- | Compar- | Compar- | Compar- |
|---|---|---|---|---|---|---|---|---|---|---|
| | | | | ative | ative | ative | ative | ative | ative | ative |
| | | Example | Example | Example | Example | Example | Example | Example | Example | Example |
| | | 1 (g) | 2 (g) | 1 (g) | 2 (g) | 3 (g) | 4 (g) | 5 (g) | 6 (g) | 7 (g) |
| Ultraviolet | Uvinul 3050 | 4 | 8 | — | — | — | — | — | — | — |
| absorber | (Dihydroxy- | | | | | | | | | |
| | benzophenone- | | | | | | | | | |
| | based) | | | | | | | | | |
| | Uvinul 3039 | — | — | — | 4 | — | — | — | — | — |
| | (Cyanoacrylate | | | | | | | | | |
| | based) | | | | | | | | | |
| | Tinuvin | — | — | — | — | 4 | — | — | — | — |
| | 477(triazine- | | | | | | | | | |
| | based) | | | | | | | | | |
| | Tinuvin | — | — | — | — | — | 2 | — | — | — |
| | 970(benzotri- | | | | | | | | | |
| | azole - based) | | | | | | | | | |
| | 2-hydroxy-4-n- | — | — | — | — | — | — | 2 | — | — |
| | octyloxybenzo- | | | | | | | | | |
| | phenone | | | | | | | | | |
| Photoinitiator | Omnir | 2 | 2 | 2 | 2 | 2 | 2 | 2 | 0.1 | 1 |
| | ad 819 | | | | | | | | | |
| Mono- | 4-HBA | 7 | 7 | 7 | 7 | 7 | 7 | 7 | — | — |
| functional | 2-EHA | 54 | 54 | 54 | 54 | 54 | 54 | 54 | — | — |
| (meth)acrylate | THF-A | 14 | 14 | 14 | 14 | 14 | 14 | 14 | — | — |
| monomer | EHDG-AT | 10 | 10 | 10 | 10 | 10 | 10 | 10 | — | — |
| (Meth)acrylate | UF-C051 | 3 | 3 | 3 | 3 | 3 | 3 | 3 | — | — |
| oligomer | UF-C052 | 3 | 3 | 3 | 3 | 3 | 3 | 3 | — | — |
| | UN6304 | 7 | 7 | 7 | 7 | 7 | 7 | 7 | — | — |
| | Acryl | — | — | — | — | — | — | — | 100 | 100 |
| | polymer | | | | | | | | | |
| Additive | Takenate | — | — | — | — | — | — | — | 2.5 | 2.5 |
| | D110N | | | | | | | | | |
| Hardener | APG700 | — | — | — | — | — | — | — | 30 | 30 |
| Dispersant | MHI | — | — | — | — | — | — | — | 0.2 | 0.2 |
| | black #273 | | | | | | | | | |

### Data on the Materials in Table 1

Uvinul 3050:2,2′,4,4′-tetrahydroxybenzophenone
Uvinul 3039: (2-ethylhexyl)-2-cyano-3,3-diphenylacrylate
Tinuvin 970:2-(2H-benzotriazol-2-yl)-6-dodecyl-4-methylphenol
Omnirad 819: Bis(2,4,6-trimethylbenzoyl)phenyl phosphine oxide, (a product of IGM Resins)
4-HBA: 4-hydroxybutyl acrylate (a product of Osaka Organic Chemical Industry Ltd)
2-EHA: 2-ethylhexyl acrylate (a product of Toagosei Co., Ltd.)
THF-A: Tetrahydrofurfuryl acrylate (a product of Kyoeisha Chemical Co., Ltd)
EHDG-AT: 2-ethylhexyl-diglycol acrylate (a product of Kyoeisha Chemical Co., Ltd)
UF-C051: Urethane acrylate (weight-average molecular weight 35,000, a product of Kyoeisha Chemical Co., Ltd)
UF-C052: Urethane acrylate (weight-average molecular weight 10,000, a product of Kyoeisha Chemical Co., Ltd)
UN6304: Urethane acrylate (weight-average molecular weight 10,000, a product of Negami Chemical Industrial Co., Ltd)
Acryl polymer: Acryl-based Polymer A1 of patent document KR 10-2021-0116446 (weight-average molecular weight 1,200,000)
Takenate D110N: 75% ethyl acetate solution of trimethylolpropane adduct of xylylene diisocyanate (a product of Mitsui Chemicals)
APG700: Polypropylene glycol #700 (n=12) diacrylate (functional group equivalent weight 404 g/eq)
MHI black #273: Carbon black pigment dispersant (a product of Mikuni Shikiso Co., solid powder 17.6%)

Referring to Table 1, in the resin compositions according to the Examples and Comparative Examples, it can be seen that the same material of the photoinitiator is provided at the same weight. In the resin compositions according to the Examples and Comparative Examples, it can be seen that the same material of the monofunctional (meth)acrylate monomer is provided at the same weight. It can be seen that the monofunctional (meth)acrylate monomer includes 4-hydroxybutyl acrylate (4-HBA), 2-ethylhexyl acrylate (2-EHA), tetrahydrofurfuryl acrylate (THF-A), and 2-ethylhexyl-diglycol acrylate (EHDG-AT).

In the resin composition according to Example 1, 85 g among 104 g of the total weight of the resin composition corresponds to the monofunctional (meth)acrylate monomer, and when the total weight is converted to 100 wt %, the weight of the monofunctional (meth)acrylate monomer corresponds to about 81.7 wt %. In the resin composition according to Example 2, 85 g among 108 g of the total weight of the resin composition corresponds to the monofunctional (meth)acrylate monomer, and when the total weight is converted to 100 wt %, the weight of the monofunctional (meth)acrylate monomer corresponds to about 78.7 wt %. Therefore, it can be seen that each weight of the monofunctional (meth)acrylate monomers in the resin compositions according to Examples 1 and 2 with respect to 100 wt % of the total weight of the resin compositions, falls within the weight range of the monofunctional (meth)acrylate monomer according to an embodiment (e.g., about 75 wt % to about 85 wt %).

Referring to Table 1, it can be seen that the same materials of the (meth)acrylate oligomer may be provided at the same weight in each of the resin compositions according to the Examples and Comparative Examples. It can be seen that the (meth)acrylate oligomer having the weight-average molecular weight of about 5,000 to about 40,000 is provided in the resin compositions according to the Examples and Comparative Examples.

Referring to Table 1, it can be seen that, in the resin compositions according to the Examples and Comparative Examples, the ultraviolet absorber is provided in different weights and/or different materials are provided as the ultraviolet absorber. The resin compositions according to Comparative Examples 1 to 7 include no dihydroxybenzophenone-based ultraviolet absorber.

It can be seen that the resin composition according to Examples 1 and 2 are manufactured by being provided with the dihydroxybenzophenone-based ultraviolet absorber. In the resin composition according to Example 1, 4 g among 104 g of the total weight of the resin composition corresponds to the ultraviolet absorber, and when the total weight is converted to 100 wt %, the weight of the ultraviolet absorber corresponds to about 3.8 wt %. In the resin composition according to Example 2, 8 g among 108 g of the total weight of the resin composition corresponds to the ultraviolet absorber, and when the total weight is converted to 100 wt %, the weight of the ultraviolet absorber corresponds to about 7.4 wt %. Therefore, it can be seen that the ultraviolet absorber of the resin compositions according to Examples 1 and 2 fall within the weight range (e.g., about 2 wt % to about 10 wt %) with respect to 100 wt % of the total weight of the resin composition, of the dihydroxybenzophenone-based ultraviolet absorber according to an embodiment.

### 2. Evaluation of Adhesive Member

Transmittance and a 180° peel force of the adhesive member formed from the resin compositions according to the Examples and Comparative Examples were evaluated, and the evaluated results are listed in Table 2 below. Hereinafter, evaluation methods will be described in more detail.

### Transmittance of Adhesive Member

The manufactured resin composition was provided between slide glasses S112s made by Matsunami Glass Ind., Ltd mounted together with a spacer having a thickness of 10 μm. Thereafter, the resin composition was cured by irradiating ultraviolet light. UV-LED lamps having a peak wavelength at 365 nm (spectral distribution range: about 350 nm to about 390 nm) and at 395 nm (spectral distribution range: about 370 nm to about 420 nm) were used so as to provide light of 800 mJ/cm² and 400 mJ/cm², respectively. Then, ultraviolet light was irradiated using the UV-LED lamp having a peak wavelength at 395 nm so as to provide light of 4,000 mJ/cm², so that an adhesive member sample between the slide glasses was obtained. For the adhesive member sample, transmittances for light having wavelengths of 400 nm and 450 nm were measured using a spectrophotometer V770 (UV-Visible & NIR Spectrometer, JASCO Corporation).

### 180° Peel Force of Adhesive Member

The manufactured resin composition was applied using an inkjet device in a thickness of 100 μm on the soda-lime glass (a product of Central Glass Co., Ltd) having a size 26 mm×76 mm. As the inkjet device DevicePrinter-CX (a product of MicroJet Technology Co., Ltd) mounted with KM1024i (a product of Konika Minolta, INC) was used. Ultraviolet light was irradiated to the applied resin composition using UV-LED lamps having peak wavelengths at 365 nm (spectral distribution range: about 350 nm to about 390 nm) and at 395 nm (spectral distribution range: about 350 nm to about 390 nm) so as to provide light of 800 mJ/cm² and 400 mJ/cm², respectively. Thereafter, a PET film (thickness: 50 μm, a product of TOYOBO Co., Ltd., Product No: A4360) having a size of 20 mm×150 mm was joined at a joining pressure of 0.15 MPa. After joining, ultraviolet light was irradiated from the PET film side using the UV-LED lamp having a peak at 395 nm so as to provide light of 4,000 mL/cm² to cure the resin composition, thereby obtaining the sample.

For the obtained sample, a peel force was measured three times at a speed of 300 nm/min at 25° C. such that a peeling angle was 180°, using a universal testing machine (Instron Corporation, Product No. 5965). The measurement followed the JIS Z0237 standard. An average value of peeling for about 50 mm was measured, the obtained value was multiplied by 1.25 to record the peel force for a width of 25 mm. Because, in Table 2, the resin composition according to Comparative Example 4 was not cured, the peel force thereof was not measured. Because the resin compositions according to Comparative Examples 6 and 7 were non-ejectable through the inkjet device, the peel forces thereof were not measured.

TABLE 2

| | Example | Example | Comparative | Comparative | Comparative | Comparative | Comparative | Comparative | Comparative |
|---|---|---|---|---|---|---|---|---|---|
| | 1 | 2 | Example 1 | Example 2 | Example 3 | Example 4 | Example 5 | Example 6 | Example 7 |
| 180° peel force | 1000 | 980 | 950 | 960 | 980 | Incurable | 980 | Non- | Non- |
| [gf/25 mm] | | | | | | | | ejectable | ejectable |
| Transmittance for | 4 | 1 | 90 | 85 | 20 | 2 | 87 | 88 | 88 |
| light of a 400 nm | | | | | | | | | |
| wavelength [%] | | | | | | | | | |
| Transmittance for | 90 | 91 | 91 | 90 | 88 | 86 | 90 | 91 | 91 |
| light of a 450 nm | | | | | | | | | |
| wavelength [%] | | | | | | | | | |

Referring to Table 2, it can be seen that each of the adhesive members formed from the resin compositions according to Examples 1 and 2 has a 180° peel force of about 800 gf/25 mm or greater for at least one among a glass substrate and a polymer substrate at about 25° C. It can be seen that each of the adhesive members formed from the resin compositions according to Examples 1 and 2 has a transmittance of about 0% or greater and less than about 5% for light having a wavelength of about 400 nm; and a transmittance of about 85% to about 99% for light having a wavelength of about 450 nm. The transmittances of the adhesive members formed from the resin compositions according to Examples 1 and 2 fall within the transmittance range of the adhesive member according to an embodiment for light having wavelengths of 400 nm to about 450 nm. Therefore, it can be seen that the resin composition according to an embodiment including the dihydroxybenzophenone-based ultraviolet absorber, the photoinitiator absorbing light in a wavelength region of about 400 nm to about 450 nm, at least one monofunctional (meth)acrylate monomer, and at least one (meth)acrylate oligomer may exhibit excellent ultraviolet shielding rate, and a high transmittance for visible light after curing. In addition, it can be seen that the resin composition according to an embodiment nay exhibit excellent adhesion. It can be seen that the adhesive member formed from the resin composition according to an embodiment may exhibit an excellent ultraviolet shielding rate, an excellent transmittance for visible light, and excellent adhesion, and the display including the adhesive member may exhibit excellent display quality and excellent reliability.

Each of the adhesive members formed from the resin compositions according to Comparative Examples 1 to 3, and 5 has a 180° peel force of 800 gf/25 mm or greater at 25° C. for at least one among a glass substrate and a polymer substrate. However, there is a difference in that each of the adhesive members formed from the resin compositions according to Comparative Examples 1 to 3, and 5 has a transmittance of about 5% or greater for light having a wavelength of 400 nm, compared to the adhesive members formed from the resin composition according to Examples 1 and 2. As described above, the resin compositions according to Comparative Examples 1 to 3, and 5 include no dihydroxybenzophenone-based ultraviolet absorber, unlike the resin compositions according to Examples 1 and 2.

Because the resin composition according to Comparative Example 4 was not cured, the 180° peel force thereof was not measured. Because the resin compositions according to Examples 6 and 7 could not be provided using the inkjet device, the 180° peel forces thereof were not measured. The resin compositions according to Examples 6 and 7 include an acryl polymer and a solvent having a molecular weight of less than 120, and thus could not be provided using the inkjet device. As described above, the resin compositions according to Comparative Examples 4,6, and 7 include no dihydroxybenzophenone-based ultraviolet absorber, unlike the resin composition according to Examples 1 and 2.

The resin composition according to an embodiment may include a in a wavelength region of about 400 nm to about 450 nm, at least one monofunctional (meth)acrylate monomer, and at least one (meth)acrylate oligomer. The adhesive member according to an embodiment may include a polymer derived from the resin composition according to an embodiment. The display device according to an embodiment may include the adhesive member according to an embodiment between the display panel and the window. The adhesive member according to an embodiment may have a 180° peel force of about 800 gf/25 mm or greater at about 25° C. for at least one among a glass substrate and a polymer substrate. Therefore, the resin composition according to an embodiment may exhibit excellent applicability before being cured and may exhibit excellent adhesion after being cured. The adhesive member formed by curing the resin composition according to an embodiment and the display device including the same may exhibit excellent reliability.

The resin composition according to an embodiment includes a dihydroxybenzophenone-based ultraviolet absorber, a photoinitiator that absorbs light in the wavelength range of about 400 nm to about 450 nm, a monofunctional monomer, and an oligomer, and thus may exhibit excellent applicability before being cured and strong adhesion after being cured.

The adhesive member according to an embodiment, and the display device according to an embodiment including the adhesive member may include a polymer derived from the resin composition according to an embodiment, thereby exhibiting excellent reliability.

Although example embodiments of the present disclosure have been described, it is understood that the present disclosure should not be limited to these embodiments but various changes and modifications can be made by one ordinary skilled in the art within the spirit and scope of the present disclosure as hereinafter claimed.

Accordingly, the technical scope of the present disclosure is not intended to be limited to the contents set forth in the detailed description of the specification, but is intended to be defined by the appended claims, and equivalents thereof.

What is claimed is:

1. A resin composition comprising:
a dihydroxybenzophenone-based ultraviolet absorber;
a photoinitiator that absorbs light in a wavelength region of about 400 nm to about 450 nm;
at least one monofunctional (meth)acrylate monomer; and
at least one (meth)acrylate oligomer,
wherein, the resin composition after photocuring has a 180° peel force of about 800 gf/25 mm or greater for at least one among a glass substrate and a polymer substrate, as measured at about 25° C. according to the JIS Z0237 standard.

2. The resin composition of claim 1, wherein:
a transmittance for light having a wavelength of about 400 nm after photocuring is about 0% or greater and less than about 5%; and
a transmittance for light having a wavelength of about 450 nm after photocuring is about 85% to about 99%.

3. The resin composition of claim 1, wherein the dihydroxybenzophenone-based ultraviolet absorber comprises 2,2′,4,4′-tetrahydroxybenzophenone.

4. The resin composition of claim 1, wherein the dihydroxybenzophenone-based ultraviolet absorber has a weight of about 2 wt % to about 10 wt % with respect to 100 wt % of the total weight of the resin composition.

5. The resin composition of claim 1, wherein the photoinitiator comprises bis(2,4,6-trimethylbenzoyl)phenyl phosphine oxide.

6. The resin composition of claim 1, wherein the (meth)acrylate oligomer has a weight-average molecular weight of about 5,000 to about 40,000.

7. The resin composition of claim 1, wherein the monofunctional (meth)acrylate monomer comprises at least one among 4-hydroxybutyl acrylate (4-HBA), 2-ethylhexyl acrylate (2-EHA), tetrahydrofurfuryl acrylate (THF-A), and 2-ethylhexyl-diglycol acrylate (EHDG-AT).

8. The resin composition of claim 1, wherein the monofunctional (meth)acrylate monomer has a weight of about 75 wt % to about 85 wt % with respect to 100 wt % of the total weight of the resin composition.

9. The resin composition of claim 1, wherein the resin composition is provided through an inkjet printing method or a dispensing method.

10. An adhesive member comprising a polymer derived from a resin composition comprising a dihydroxybenzophenone-based ultraviolet absorber, a photoinitiator that absorbs light in a wavelength region of about 400 nm to about 450 nm, at least one monofunctional (meth)acrylate monomer and at least one (meth)acrylate oligomer,
wherein, the adhesive member has a 180° peel force of about 800 gf/25 mm or greater for at least one among a glass substrate and a polymer substrate, as measured at 25° C. according to the JIS Z0237 standard.

11. The adhesive member of claim 10, wherein:
a transmittance for light having a wavelength of about 400 nm is about 0% or greater and less than about 5%; and
a transmittance for light having a wavelength of about 450 nm is about 85% to about 99%.

12. The adhesive member of claim 10, wherein the dihydroxybenzophenone-based ultraviolet absorber comprises 2,2′,4,4′-tetrahydroxybenzophenone.

13. The adhesive member of claim 10, wherein the weight of the dihydroxybenzophenone-based ultraviolet absorber is about 2 wt % to about 10 wt % with respect to 100 wt % of the total weight of the resin composition.

14. The adhesive member of claim 10, wherein the photoinitiator comprises bis(2,4,6-trimethylbenzoyl)phenyl phosphine oxide.

15. The adhesive member of claim 10, wherein the (meth)acrylate oligomer has a weight-average molecular weight of about 5,000 to about 40,000.

16. A display device comprising:
a display panel;
a window on the display panel; and
an adhesive member between the display panel and the window, and having a 180° peel force of about 800 gf/25 mm or greater for at least one among a glass substrate and a polymer substrate, as measured at about 25° C. according to the JIS Z0237 standard,
wherein the adhesive member comprises a polymer derived from a resin composition comprising a dihydroxybenzophenone-based ultraviolet absorber, a photoinitiator that absorbs light in a wavelength region of about 400 nm to about 450 nm, at least one monofunctional (meth)acrylate monomer and at least one (meth)acrylate oligomer.

17. The display device of claim 16, wherein the adhesive member has a transmittance of about 0% or greater and less than about 5% for light having a wavelength of about 400 nm; and a transmittance of about 85% to about 99% for light having a wavelength of about 450 nm.

18. The display device of claim 16, wherein the dihydroxybenzophenone-based ultraviolet absorber comprises 2,2′,4,4′-tetrahydroxybenzophenone.

19. The display device of claim 16, wherein the weight of the dihydroxybenzophenone-based ultraviolet absorber is about 2 wt % to about 10 wt % with respect to 100 wt % of the total weight of the resin composition.

20. The display device of claim 16, wherein the photoinitiator comprises bis(2,4,6-trimethylbenzoyl)phenyl phosphine oxide.

21. The display device of claim 16, wherein the display device does not include a polarizer.

22. The display device of claim 16 further comprising an input-sensing part between the display panel and the window,
wherein the adhesive member is between the display panel and the input-sensing part, or between the input-sensing part and the window.
